(19) United States
(12) Patent Application Publication
(10) Pub. No.: US 2008/0307525 A1
(43) Pub. Date: Dec. 11, 2008

(54) SYSTEM AND METHOD FOR EVALUATING SECURITY EVENTS IN THE CONTEXT OF AN ORGANIZATIONAL STRUCTURE

(75) Inventor: Michael D. Nickle, Denver, CO (US)

Correspondence Address: PILLSBURY WINTHROP SHAW PITTMAN, LLP, P.O. BOX 10500, MCLEAN, VA, 22102, US

(73) Assignee: Computer Associates Think, Inc., Islandia, NY (US)

(21) Appl. No.: 11/758,371

(22) Filed: Jun. 5, 2007

(51) Int. Cl. G06F 11/00

(52) U.S. Cl. 726/22

(57) ABSTRACT

A system and method is provided for evaluating security threats to an enterprise network. The relative severities of security threats are determined, based in part, on the context of each threat within the enterprise network and in relation to the operation of a business. As a result, it is possible to prioritize security threats having the greatest magnitude and also threats that are directed against the most valuable business network devices. The invention comprises a plurality of network agents operating on a plurality of network devices for generating event messages. The event messages contain security data and are forwarded to an event manager for analysis. The event manager comprises an event correlator and an asset context manager. The event correlator detects security threats from the interrelationships between the security data contained in the event messages. In addition, the asset context manager utilizes business context knowledge specific to a particular business or business unit to determine a threat priority based on the importance of the threatened network device to the operation of the business.

### FIELD OF THE INVENTION

The invention relates to a security event management system for evaluating enterprise network security threats and determining threat severity in the context of a particular business mission.

### BACKGROUND OF THE INVENTION

Enterprise computer network security systems have been designed to detect and respond to a variety of security threats. Common threats to enterprise networks may fall into several broad categories including: malicious software, spoofing, scanning, eavesdropping, and other threats.

Malicious software may be manifested as viruses, worms, spyware, or other software that replicate and/or execute without authorization and with undesirable consequences. Such programs can destroy data and slow computers and the networks on which they are connected. In some cases, the propagation of these programs across an enterprise network can be recognized by a pattern of unexpected system failures among networked computers and by using firewalls and malware scanners.

In addition, security threats may occur as a result of unauthorized users gaining access to the enterprise system, or by authorized users performing operations for which they are not approved. For instance, a network may be spoofed by an unauthorized user who is misidentified and who effectively pretends to have an authorized identity. As a further example, an unauthorized user may discover a valid user login by scanning, via repeatedly guessing different user logins, or by eavesdropping on communications containing login information. Enterprise security network systems may detect threats of these types by recognizing deviations from typical user patterns.

Other types of threats also exist.

However, despite having the ability to detect enterprise network security threats, conventional security systems do not prioritize these threats within a business context. Consequently, security threats to critical network devices such as, for example, servers containing credit card and social security numbers, may not be prioritized over security threats less critical to network resources.

Accordingly, there is a need for improving the effectiveness and efficiency of computer security systems operating on large distributed heterogeneous computer networks by considering security threats within the context of a particular business or operational mission.

### BRIEF SUMMARY OF THE INVENTION

The invention distinguishes high risk threats from incidental threats, false alarms, and normal system operations. Furthermore, the invention analyzes threats within a business context in order prioritize security threats that are critical to the mission of the business. Consequently, security specialists can increase their response rate to threats and vulnerabilities that have the most impact on the business.

In some instances, different network devices connected via an enterprise network may be deemed to be more important to a particular business based on the value of the services performed by the respective network device. For example, an Internet merchant might consider a security threat against an ecommerce server having credit card information as more severe than a security threat directed towards a computer used for classroom training. In another example, a defense contractor might consider proprietary diagrams of a next generation system to be of critical importance, email connectivity to be of high importance, and maintaining public presence to be of a lesser importance. As a result, the defense contractor might consider security threats compromising the logins of a group of individuals authorized to access those diagrams to have a greater severity than threats directed towards an email or webpage server.

The event management system of the invention manages security events across an enterprise computer network, in part, by analyzing the context of the security events. An enterprise network may include numerous devices (i.e. nodes) connected by local area networks (LAN's), wide area networks (WAN's), and/or other networks. Each node may be any electronic networked device that accesses and communicates across the enterprise network. For example, nodes may be client computers such as, for example, desktops, laptops, handhelds, or other client devices; servers for providing email, web pages, files, ecommerce, or other services; network appliances such as, for example, printers, fax machines, or copy machines; or networking elements such as, for example, routers, switches, firewalls, or other elements.

The invention includes an event manager that functions as the central clearing house for security related events by aggregating security data describing security related events detected at individual network nodes. After aggregating security event data, the event manager identifies potential security threats by analyzing the individual events separately. The event manager also detects correlations between individual events in order to detect security threats that occur across multiple network nodes or over an extended period of time.

Following the identification of potential security threats, the severity of the threats may be determined in a business context based on the nature of the threat, the network nodes from which the threat originated, the network nodes to which the threat is directed, and/or other factors. The invention may include an asset context manager that interfaces with the event manager to determine the severity of the threat from a business context. In some embodiments, the asset context manager may include business context knowledge that is specific to a business context of a particular user business. As described herein, certain threats may pose different risks to different businesses. As such, the business context knowledge utilized by the asset context manager may be customized for each user business and/or may differ between business units or other subunits of a single organization. The asset context manager may utilize the business context knowledge to assign threat values to security events or otherwise prioritize security events in the context of a business mission. Thus, the invention provides a layer of customized threat assessment based specifically on a particular business mission.

Different security priorities may be determined using the asset context manager to ascertain the relative value of a threatened device node to the operation of the business. As a result, businesses that place different degrees of importance on various portions of their enterprise networks can customize their business context knowledge so that they can tailor security responses to accurately reflect these variances. Furthermore, the business context knowledge can be reevaluated and altered at any time so that the invention provides a mechanism by which a business can modify their analysis of threat severity as the composition of their enterprise network changes with time.

These and other objects, features, and advantages of the invention will be apparent from the detailed description and the attached drawings. It is understood that both the foregoing summary and the following detailed description are for exemplification of features of the invention and are not restrictive as to the scope of the invention.

### BRIEF DESCRIPTION OF THE DRAWINGS

FIG. 1 illustrates a security event management system having an asset context manager according to various embodiments of the invention.

FIG. 2 illustrates an example of a detailed view of an event manager according to various embodiments of the invention.

FIG. 3 illustrates an example of a method of evaluating security events according to various embodiments of the invention.

### DETAILED DESCRIPTION OF THE INVENTION

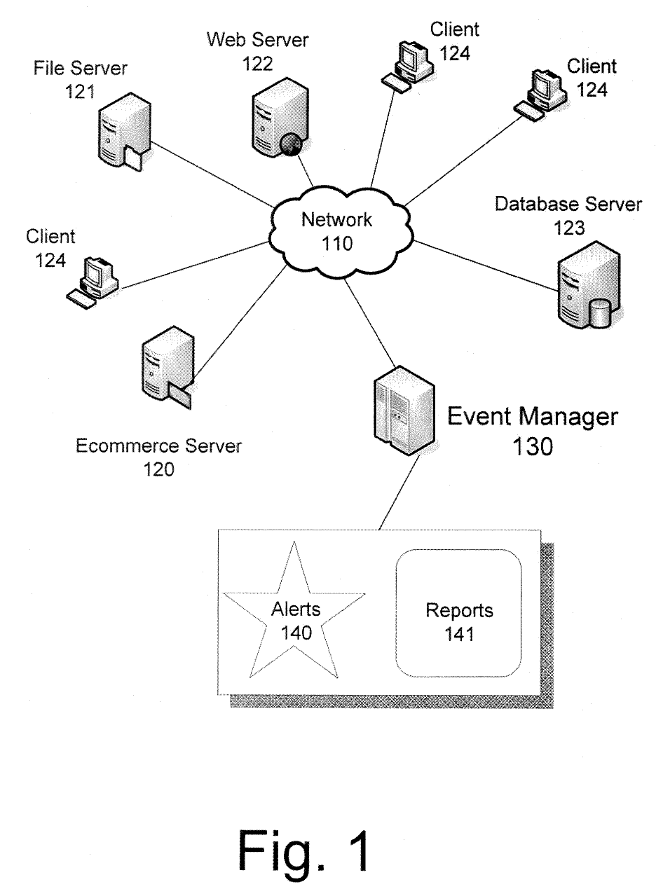

FIG. 1 illustrates an example of an event manager 130 according to various embodiments of the invention that resides on or otherwise operates in concert with an enterprise network 110, network device nodes 120-124, and/or other elements or enterprise information systems. Enterprise network 110 may be a heterogeneous computer network that includes, for example, a plurality of LAN's, WAN's, and network device nodes 120-124. Network device nodes 120-124 may include any electronic device, either wired or wireless, that may be connected to communicate via enterprise network 110. Individual network nodes 120-124 may include, for example, a client 124, server (e.g. an eCommerce server 120, file server 121, web server 122, database server 123, or other server), or network component.

More specifically, client nodes 124 can be any desktop, laptop, handheld, or other computer running a variety of operating systems such as, for example, Microsoft Windows™, MacOS™, IBM OS/2, Unix, Linux, or Sun Solaris. In addition, client nodes 124 can be network appliances such as access card readers, security cameras, printers, copiers, fax machines, or other network appliances. In one example, the client nodes 124 communicate with network nodes including servers 120-123 which may provide eCommerce, file, web, database, and/or other services. The enterprise network can facilitate these communications by transmitting data via other network nodes including routers and switches (not shown), and protect network communications using firewall device nodes (not shown).

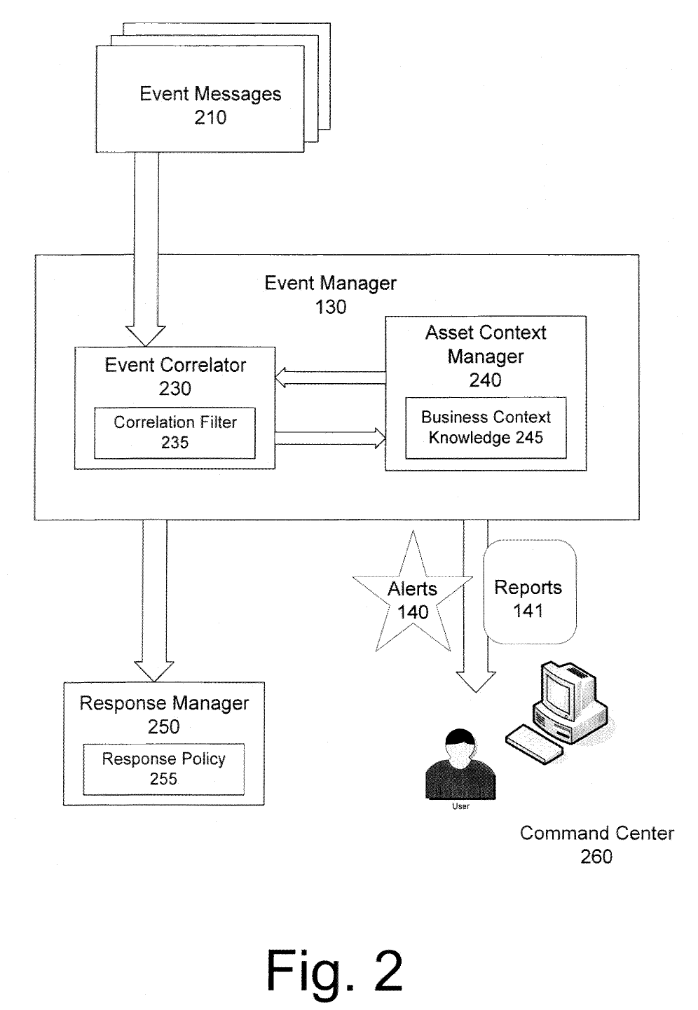

As illustrated in FIG. 2, security issues affecting individual network nodes are encapsulated as data in event messages 210 and are forwarded to an event manager 130 for identification and analysis of security threats. At each network node 120-124, security data may be generated as a result of the operation of the node itself or as a result of an interaction with another node on the network. For example, scanning software located on a personal computer may detect that it has been infected by a virus, or a network router may receive a significant number of falsified data packets. This information can be captured by a hardware or software agent that monitors security data generated at the node. Furthermore, the raw security data can be converted into a standard format and communicated by the agent to a network node having a security event manager 130 for further analysis. The security data can be sent as event messages 210 in real-time to a security event manager 130 and/or archived for historical analysis. In some embodiments, the agent may perform basic filtering on the security data in order to identify which security events should be forwarded to a security event manager 130 and which events can be resolved locally, thereby minimize the movement of unnecessary data across the network.

The security data transmitted by the agent of a network node 120-124 to an event manager 130 is formatted into a structured event message for conveying the essential aspects of the security event. In particular, event messages 210 uniquely identify and describe fundamental characteristics of particular security issues including (1) a description of the nature of the security issue and (2) an accurate timestamp indicating the time of occurrence. This information is communicated by the event messages 210 through a plurality of predefined fields. Each predefined field is either an identifying field for uniquely distinguishing one event from other events, or a non-identifying field for describing the security issue. In some instances, fields can indicate the node where a security issue was detected, the node where an agent is running, the node at which the responsible event manager 130 resides, or other information. In some instances, fields include the class of a security issue, time, description, data values of relevant conditions, a network device node's response policy, type of response undertaken, or other fields.

The event messages 210 generated in response to a security event may include one of a discrete, condition, or alarm event message. Discrete and condition event messages describe a particular state of the enterprise network nodes. A discrete event message results from a single instance of a security issue that is self-contained in nature and does not require further update. For instance, a discrete event indicating a failed login attempt can be produced as a consequence of a user submitting an improper username or password.

Condition event messages differ from discrete event messages in that they communicate a security issue that persists over time and may require a further follow-up action. For instance, a condition event message indicating a power outage on a portion of the enterprise network can be periodically updated to communicate that a network node is not operating, or alternatively, that a network node has come back online.

Alarm event messages differ from both discrete and condition event messages in that the alarm is an indication of a conclusion drawn from discrete events or condition events. In other words, an alarm event message communicates a determination that one, or more, security events violate a security a policy. The alarm may indicate that a violation has occurred and/or that a particular action was taken in response. While it is necessary to resolve the underlying network cause in order to address discrete events and condition events, alarm events can be dismissed or persist irrespective of the underlying network cause. As a result, a security event manager or human security specialist can choose to ignore non-critical alarm events, or alternatively, leave activated alarms that may suggest a continuing or future network vulnerability.

Event messages 210 are generated in order to inform an event manager 130 of existing security issues. Event manager 130 serves as the central hub for the monitoring of security information. Furthermore, event manager 130 enables the detection of larger and more sophisticated security threats that are not limited to a single network node but are dispersed over multiple network nodes.

In some embodiments, enterprise network 110 may include a single, central event manager 130. Having a single network manager 130 may be adequate for smaller enterprise networks and simplify the network topology of larger enterprise networks. However, in some embodiments, multiple event managers 130 can be provided and arranged hierarchically. When providing multiple event managers 130, a single event manager may only be responsible for providing security management to a portion of the network, and for generating or forwarding appropriate event messages to associated event managers. Arranging multiple event managers 130 hierarchically on the network may lessen the burden on a single event manager by distributing event processing and reducing the amount and distance that security data must be transmitted across network 110.

Event manager 130 (or multiple event mangers 130 working collectively) determines an overall view of potential security threats by filtering event messages 210 received from agents and/or associated event managers. Event messages 210 can be analyzed by the event manager 130 to identify and eliminate redundant security events and to further consolidate the amount of security data. In particular, an event filter may be used to describe criteria for identifying events of interest and for specifying comparisons made between event messages 210. As a result, the event management system of the invention may monitor and store security events regarding individual network nodes, and may also correlate events across multiple nodes in order to detect more dispersed or large-scale security threats.

The correlation of events can be performed by an event correlator 230 capable of determining relationships among individual event messages 210 and link separate, but related security events. The event correlator 230 may implement a specified user-policy in identifying dispersed and large-scale attacks by using, for example, a correlation filter 235. Correlation filter 235 may be similar to an event filter in that it may enumerate a set of security conditions. However, correlation filter 235 may be different in that it filters the security data contained in a plurality of event messages 210 in such a way as to determine correlations between multiple events.

The event correlator 230 may distinguish a multitude of interconnected security events from single events that may not be indicative of a significant security threat. For instance, an instance of a user entering an improper password may simply be an isolated event. However, repeated submissions of improper logins may signify a scanning attack in which an individual attempts to guess a user login. By correlating the login attempts with the user's typical login pattern, it may be possible to discern unusual behavior that signals a security threat.

For example, correlating the login attempts with the date and time of logins typical of the legitimate user might reveal that a series of login attempts is unusual because they do not occur during the user's work hours. As a further example, an individual may attempt to masquerade as another by fabricating an authorized user's identity. This could be discovered by correlating the files accessed by the individual with the employee's workgroup or position. For instance, a security threat might be realized if an individual using a login belonging to a secretary in the financial department accesses files belonging to the general legal council of the company. As still a further example, a pattern of computers in location or time having slow response times and unexpected failures can be evidence of the replication and propagation of a worm across an enterprise network. Upon discovery of these or other threats, the event correlator 230 can respond by creating, for example, a modified event, a new event, or an alarm that can be directly acted upon or used during further correlations. However, in some embodiments, single events may be utilized to identify a security threat and/or initiate a response to that threat.

Following the detection of security threats arising from individual or related event messages 210, the threat severity can be determined after considering the magnitude of the threat and the particular portions of the enterprise network affected. In particular, the event correlator 230 can further access an asset context manager 240 in order to determine the relative importance of the vulnerable system.

Asset context manager 240 may include or access business context knowledge 245 which provides customized information as to how specific security threats are prioritized and/or acted upon for a specific business or business unit. In some embodiments, asset context manager may utilize business context knowledge 245 to assign a threat value to a security event such that security threats are prioritized with respect to one another. As such, asset context manager 240 utilizes business context knowledge 245 to take into consideration the relative importance of attacked assets from a business context. In this way, event manager 130 can prioritize responses to security threats that most jeopardize the mission of the business. For instance, as in the example provided above, a defense contractor having previously undisclosed, proprietary diagrams of critical importance might utilize business context knowledge 245 to assign a higher threat value to security threats compromising the logins of individuals authorized to access proprietary diagrams than to threats directed towards a webpage server. As a result of considering the security threat in the context of the operation of the business, a security specialist, network administrator, or other personnel may be better able to understand, prioritize, and respond to a multitude of threats directed against the network.

For example, upon receipt of a security event message 210, asset context manager 240 may look at certain attributes of the event message to discern certain information used in applying the event to the particular business context. For example, asset content manager 240 may look at an “event ID” which may indicate a description of the actions causing generation of security event message 210 (e.g., a failed log-in attempt) and may look at a source IP address associated with the event (i.e., the identity of the asset that is trying to be assessed, e.g., a file server). Using the IP address of the file server as source data, asset context manager 240 may compare the IP address against business context knowledge 245 and find that the server is a secure web server that is listed as a high value or critical asset. Asset context manager may then assign a higher threat value to the potential security event posed by the failed login than would be assigned to a similar failed login of a webserver.

In some embodiments, the asset context manager 240 may interface with either or both of event correlator 230 and event manager 130. Asset context manager 240 can access a data repository having information about the network device located at each network node 120-124 and data indicating the relative value of the network device 120-124 to the business. This asset and criticality information can be used to build and/or add to business context knowledge 245.

In some embodiments, business context knowledge 245 may include a data store (e.g., a lookup table, database, or other data structure or set thereof) having one or more elements that may be used to determine whether an event is critical. For example, in one embodiment, a listing of users may be collected and tagged for criticality (for example, the executive management team and their support staff would all be tagged as high criticality users). In another example, specific groups with access to high value data stores (i.e., finance, accounting, HR) may be collected and tagged for criticality. In yet another example, the names of specific applications, application modules, and/or database instances as they would show in logs (e.g., SAP HR, Accounts_Payable) as well as IP addresses, subnets and hostnames of systems with varying levels of criticality may be collected and stored or otherwise used as business context knowledge 245.

Following a determination that a significant security threat is directed towards an important business asset 120-124 on the enterprise network 110, an alarm event can be generated in the form of an alert 140 to provide notification of the security threat to a security specialist or associated event manager. The determination of an alarm event may result from the presence of a single event, an existing state when another event occurs, or the recurrence of a particular event within a fixed time window. Further, an alarm event may be a combination of the recurrence of a particular event within a fixed time window when certain state or states are present. An alarm can be defined to activate based on a single event or set of events, and may be further defined to respond based on a determination made by a response manager 250.

The response manager 250 can interface with an event manager 130 and defines a response policy 255. Response policy 255 can be a set of rules that are used to determine the actions taken when an alarm event is generated based on a particular identified security threat. As a result of the determination made by the asset context manager 240 using business context knowledge 245, the response manager 250 utilizes response policy 255 to formulate and execute a response that is prioritized by the threat and the context of the threat within the enterprise network 110 to the operation of the business. By way of example, possible responses may include imposing user compliance with security policies, for example, by requiring a user to change passwords after a predetermined period of time; inhibiting threats to high value business assets on the enterprise network, for example, by disabling logins, network ports, or services; altering a security specialist by email, text message, or mobile phone call; or other responses.

In some embodiments, network administrators or other administrative personnel can view alerts 140 and reports 141 via a command center 260 in order to administer the enterprise network 110. The network administrators can view security information via the command center 260, which can be accessed through a browser, for example. In addition, the command center 260 may enable the network administrators to interact with all of the network nodes 120-124 in the enterprise network and to view security threats to individual network nodes within the context of the business mission. As such, alarm events, alerts 140, reports 141, or other information regarding security threats that have been evaluated in the context of a business mission may be presented to one or more network administrators and action may be taken in light thereof.

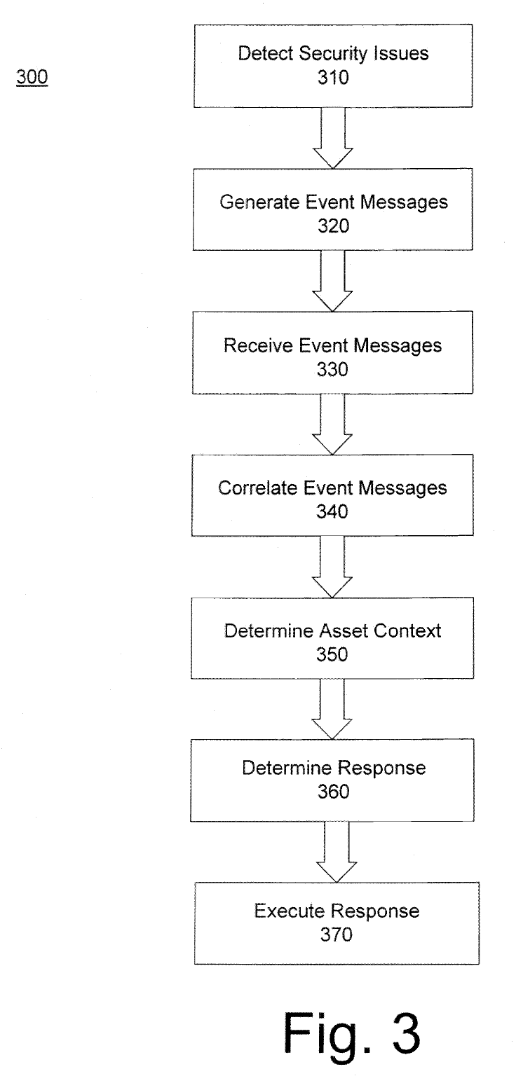

FIG. 3 illustrates a method 300, which is an example of a method for evaluating security events according to an embodiment of the invention. Security issues are detected in an operation 310 by agents that may reside on and monitor the individual network nodes 120-124. Following detection of security issues, event messages 210 are generated in an operation 320 in a standard format that identify and describe each security event. In an operation 330, event manager 130 receives event messages 210 sent by the individual agents and may perform preliminary processing on the security events, for example, by eliminating redundant security information. In some embodiments, the security events (by way of event messages 210) may be correlated in an operation 340 in order to identify security threats that are not limited to a single security event, but are dispersed throughout a plurality of security events spread over multiple network nodes 120-124 or over time. In some embodiments, security event messages need not be correlated, for example, when the security event relates to a single isolated occurrence. In an operation 350, asset context manager 240 may utilize business context knowledge 245 to determine the relationship of the threatened network node 120-124 to the business mission. As a result of the determination of asset context manager 240, it may be possible to identify security threats that are critical due to the nature of the security threat and that are critical due to the business context of the affected network devices. Following an assessment of the severity of a security threat, a response to the threat is determined in an operation 360. Responses to security threats may include, for example, imposing user compliance with security policies, taking preventative measures, alerting a security specialist, and/or other responses. In an operation 370, the determined response may be executed. In some embodiments, a response manager or other module may determine the response. In some embodiments, an administrator may utilize a command center 260 to view alarm events, alerts 140, reports 141, and determine a response accordingly.

One skilled in the art will appreciate that the invention described herein may work with various system configurations. Accordingly, more or less of the aforementioned system components may be used and/or combined in various embodiments. It is understood that the various software modules, for example, 130, 210, 230, 240, 250, or 260 utilized to accomplish the functions described above may be maintained on one or more network devices. Furthermore, it is understood that the functions described herein may be implemented in various combinations of hardware, software, and/or firmware. Furthermore, one of skill in the art will recognize that the operations of processes or methods described herein may be performed in an order different from that presented herein. In some embodiments, not all operations may be necessary and/or additional operations may be performed.

While particular embodiments of the invention have been described, it is to be understood that modifications will be apparent to those skilled in the art without departing from the spirit of the invention. The scope of the invention is not limited to the specific embodiments described herein. Other embodiments, uses and advantages of the invention will be apparent to those skilled in art from the specification and practice of the invention disclosed herein.

We claim:

1. A network security event management system for an enterprise computer network having a plurality of network device nodes, the system comprising:
an event manager that receives one or more event messages related to the enterprise computer network;
an event correlator that correlates the one or more event messages into a security event;
a context manager that identifies one or more of the plurality of network nodes related to the security event and generates a threat value for the security event based on business context knowledge of the one or more of the plurality of network nodes; and
a response manager that formulates a response to the security event based on the threat value.

2. The network security event management system of claim 1, wherein the business context knowledge comprises a lookup table for determining the threat value.

3. The network security event management system of claim 1, wherein the business context knowledge comprises a database for determining the threat value.

4. The network security event management system of claim 1, wherein the response comprises an alarm alerting a network administrator.

5. The network security event management system of claim 1, wherein the response comprises one or more automated actions.

6. A method of managing network security events in an enterprise computer network having a plurality of network device nodes, the method comprising:
receiving one or more event messages related to the enterprise network;
correlating the received one or more event messages into a security event;
identifying one or more of the plurality of network device nodes related to the security event;
determining a threat value for the security event based on business context knowledge of the one or more identified network device nodes;
formulating a response to the security event based on the threat value.

7. The method of claim 5, wherein determining the threat value of the security event further comprises accessing a lookup table of business context knowledge.

8. The method of claim 5, wherein determining the threat value of the security event further comprises accessing a database of business context knowledge.

9. The method of claim 5, wherein formulating a response comprises alerting a network administrator via an alarm.

10. The method of claim 5, wherein the response comprises one or more automated actions.
